(19) United States
(12) Patent Application Publication
(10) Pub. No.: US 2004/0071981 A1
(43) Pub. Date: Apr. 15, 2004

(54) Derived timber products consisting of wood parts glued by means of polyisocyanates

(76) Inventors: Karl Haberle, Speyer (DE); Marcus Leubner, Ludwigshafen (DE); Eberhard Pfutze, Nackenheim (DE); Michael Schmidt, Dudenhofen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/451,379

(22) PCT Filed: Jan. 3, 2002
(86) PCT No.: PCT/EP02/00012

(30) Foreign Application Priority Data
Jan. 4, 2001 (DE) 101 00 220.3

(51) Int. Cl. B32B 27/00

(52) U.S. Cl. 428/425.1

(57) ABSTRACT

Woodbase materials comprise wood pieces glued using an adhesive composition comprising

an isocyanato-bearing prepolymer (prepolymer P) derived from

A) a component A comprising

A1) from 25 to 100% by weight of a triglyceride having two or more reactive groups which may react with isocyanate groups in an addition reaction (triglycerides A1), and

A2) from 0 to 75% by weight of another compound having one or more reactive groups which may react with isocyanate groups in an addition reaction (component A2), and

B) a component B comprising a polyisocyanate

if desired, customary auxiliaries and additives

if desired, an activator, and

if desired, a filler,

and adhesive compositions.

The invention relates to woodbase materials comprising wood pieces glued using an adhesive composition comprising

an isocyanato-bearing prepolymer (prepolymer P) derived from

A) a component A, comprising

A1) from 25 to 100% by weight of a triglyceride having two or more reactive groups which may react with isocyanate groups in an addition reaction (triglycerides A1), and

A2) from 0 to 75% by weight of another compound having one or more groups which may react with isocyanate groups in an addition reaction (component A2), and

B) a component B comprising a polyisocyanate

if desired, customary auxiliaries and additives

if desired, an activator, and

if desired, a filler.

The invention further relates to adhesive compositions for this field of use.

Adhesive compositions for the production of woodbase materials such as plywood, coreboard, continuous board and glued laminated board have imposed on them particular requirements concerning the processability of the adhesive compositions and the service properties of the woodbase materials produced using them.

As far as the processing properties are concerned, the adhesive compositions of the prior art are regarded as being in need of improvement especially with respect to storage stability and to viscosity. What is desired is a lower viscosity, so that the adhesive compositions can be transferred between vessels and conveyed more simply, by means of pumps, for example, and are easier to spread on the surfaces that are to be bonded.

With regard to the service properties, the primary requirement is that the woodbase materials a) do not emit any harmful substances such as formaldehyde, and b) have very good load-bearing properties. The latter requirement is of particular importance in the case of glued laminated board, which—as is known—is used in the form of beams or girders for structural components in buildings or ships.

Whereas the mechanical load-bearing properties of woodbase materials stored under dry conditions is generally entirely satisfactory, that of moist woodbase materials, or of woodbase materials which have dried following storage under moist conditions, is regarded as being still capable of improvement.

The significance of these properties is heightened by the fact that these parameters are tested officially and that the woodbase materials are only given official approval if they meet certain minimum requirements.

DE-A-4 412 759 discloses a formaldehyde-free, filler-containing adhesive composition based on an isocyanate-containing polyurethane prepolymer. In particular, this adhesive composition has a viscosity which is poorly suited to processing, and involves press times which are alien to practice. The viscosity is of great importance, especially for pumpability and for the ability of the adhesive composition to penetrate into the substrate that is to be bonded (adhesion).

Additionally, polyisocyanate-containing adhesive compositions are described in prior documents EP-A-1 072 620 and EP-A-1 072 621 and also EP Application No. 01 123 829.2.

It is an object of the present invention to provide adhesive compositions having good processing properties and being capable of further processing to give woodbase materials having a good performance profile, the requirement being in particular for high mechanical load-bearing properties of woodbase materials having undergone moist storage.

We have found that this object is achieved by woodbase materials and the adhesive compositions as defined at the outset.

In general, the adhesive compositions from which the woodbase materials of the invention are produced contain

up to 99.99% by weight, preferably from 70 to 99.9% by weight of the prepolymer (P)

from 0 to 10% by weight, preferably from 0.001 to 10% by weight, with particular preference from 0.1 to 2% by weight of an activator

from 0 to 20% by weight, preferably from 0 to 10% by weight, with particular preference 0% by weight of a filler, and

from 0 to 20% by weight, preferably from 0 to 15% by weight, with particular preference from 0 to 5% by weight of a customary auxiliary or additive.

Particularly preferred adhesive compositions contain virtually no effective amounts of filler and consist essentially of

up to 99.99% by weight, preferably from 80 to 99.9% by weight of the prepolymer P

from 0.001 to 10% by weight, preferably from 0.1 to 2% by weight of an activator, and

from 0 to 20% by weight, preferably from 0 to 10% by weight of an auxiliary or additive.

Where the adhesive compositions comprise effective amounts of filler, they preferably consist essentially of

up to 99.99% by weight, preferably from 70 to 99.9% by weight of the prepolymer P

from 0.001 to 10% by weight, preferably from 0.1 to 2% by weight of an activator, and

from 0.1 to 20% by weight, preferably from 1 to 15% by weight, with particular preference from 1 to 5% by weight, of an auxiliary or additive.

The woodbase materials of the invention, especially plywood, coreboard or continuous wood board, may be produced using the abovementioned adhesive compositions by the same methods by which the wood pieces of which they are composed are otherwise processed together with the otherwise customary amino resins or phenolic resins.

In particular, glued laminated board or continuous wooden board is produced from wooden boards by finger joint gluing of the narrow edges. A similar approach is taken, advantageously, for the production of continuous wooden board.

The method of finger joint gluing is common knowledge and is described later on below using as an example the finger joint gluing carried out in accordance with DIN 68140 Part 1.

In the production of glued laminated board, generally two or more plies of finger-joint-glued wooden boards are joined to one another by gluing the side faces of the wooden boards using the adhesive compositions of the invention.

In the production of the woodbase materials, and especially in the case of finger joint gluing, the use of low-filler or substantially filler-free adhesive compositions is found advantageous.

Adhesive compositions containing fillers are more difficult to process on account of the fact that with low-viscosity formulations the suspended filler sediments after a short time and must in each case be stirred up again directly prior to processing. In the case of high-viscosity formulations the suspensions, although stable, are less preferred for the reasons mentioned earlier.

Filled adhesive compositions are particularly advantageous in connection with the machine bonding of surfaces having narrow and deep incisions. A surface of this kind is encountered, for example, in the course of finger joint gluing in accordance with DIN 68140 part 1. In this case the cross sections of the finger joints are generally in the form of pointed triangles, so that a likewise pointed, triangular incision of in each case one projection of two adjacent fingers is formed. An adhesive composition is applied to the projection areas of the fingers, generally using a tool which combs through the incisions and whose adhesive-applying region is adapted in terms of its shape to the incisions. Generally, the adhesive composition is applied from the flanks of this applicator comb, which generally have approximately the same length as the projections, by means of slots arranged in this region.

In the case of filled adhesive compositions, it is necessary to clean these slots at frequent intervals in order to prevent clogging and resulting fluctuations in quality.

Filled adhesive compositions are therefore used in particular when the surfaces of the wood pieces to be glued have unevennesses and the adhesive joints have a thickness of from 0.1 to 1 mm, as is the case in particular with surface gluing. For finger joint gluing, accordingly, these adhesive compositions are considered only secondarily. Here, the thickness of the joint is generally from 0.05 to 0.2, preferably from 0.09 to 0.13 mm.

The adhesive compositions of the invention preferably contain prepolymers P whose NCO content is from 5 to 30, preferably from 10 to 20, with particular preference from 13 to 17% by weight. Their viscosity at 25° C. is from 300 to 45000, preferably from 500 to 25000 mPas.

To prepare the prepolymer P, components A and B are generally used in proportions such that the ratio of the reactive groups which react with isocyanate groups in an addition reaction to the isocyanate groups is from 0.05:1 to 0.8:1, preferably from 0.1:1 to 0.5:1.

Components A and B in the stated proportions are reacted in a manner which is common knowledge in accordance with the desired NCO content of the prepolymers P.

The components A consist preferably 75 to 100%, with particular preference substantially exclusively, of a triglyceride A1.

By triglycerides Al are meant esters of glycerol which have at least two reactive groups that may react with isocyanate groups in an addition reaction. Examples are selected from the group consisting of primary amino, secondary amino, alcoholic hydroxyl, and mercapto groups.

These compounds may be of natural, synthetic or semisynthetic origin. Among the natural triglycerides, mention should be made in particular of esters of hydroxyl-bearing carboxylic acids, such as castor oil, for example.

Semisynthetic triglycerides are compounds obtained by chemical modification of natural triglycerides. These are, for example, compounds preparable by epoxidation and subsequent hydrolysis, glycolysis and/or aminolysis of olefinically unsaturated, naturally occurring triglycerides. Such compounds are sold, for example, by Harburger Fettchemie Brinckmann & Mergell GmbH under the designation Merginat®.

It is of course also possible to use synthetic triglycerides which can be obtained, for example, by esterifying glycerol with appropriately substituted carboxylic acids.

It is preferred to use natural and semisynthetic triglycerides, with particular preference natural triglycerides, and with particular preference castor oil.

Particularly suitable components A2 are those referred to in EP-A-1 072 620 as “component A”.

Normally these are compounds containing one or more reactive groups which may react with isocyanate groups in an addition reaction. They are, for example, selected from the group consisting of primary amino, secondary amino, alcoholic hydroxyl, and mercapto groups.

Preferred components A2 are polyhydric alcohols having a molecular weight of less than 400 g/mol, such as short-chain aliphatic diols having from 2 to 14 carbon atoms, examples being 1,4-butanediol and 1,6-hexanediol.

Less preferred are what are known as macropolyols, i.e., polyhydric alcohols having a molecular weight of from 400 to 10000, containing ester or ether groups as repeating units.

The components A2 may also include, at least in part, those which may react with isocyanate groups to give urea groups; i.e., compounds containing primary or secondary amino groups, and also water. Where a filler is used, the water may also be present in the filler, as is described in prior EP Application No. 01 123 829.2.

In the case of component B, containing a polyisocyanate and preferably consisting of such a polyisocyanate, suitable isocyanates commonly include the aliphatic, cycloaliphatic, araliphatic or aromatic isocyanates known per se, preferably diisocyanates or triisocyanates. Suitable isocyanates are likewise those described in EP-A-1 072 620 as “component B”. Preference is given to 4,4′-, 2,4′- or 2,2′-diphenylmethane diisocyanate, or mixtures thereof (MDI).

Activators which can be used are compounds which are common knowledge and which accelerate the reaction of isocyanate groups and the reactive groups that may react with isocyanate groups in an addition reaction. Reactive groups which may react with isocyanate groups in an addition reaction, for the purposes of the invention, are primarily alcoholic hydroxyl groups, primary and secondary amino groups, and mercaptans, and also the hydroxyl group of water. They do not include carboxylic acid groups.

Activators of this kind are common knowledge in polyurethane chemistry and are listed, for example, in EP-A-1 072 620 as catalysts. Preference is given to tertiary amines such as dimethylmorpholine.

As auxiliaries and additives, adhesive compositions comprise customary additions such as surface-active substances, stabilizers, dyes, pigments, flame retardants, fungistatic and bacteriostatic substances, and solvents.

Customary auxiliaries and additives which are preferred are likewise given under this designation and under the designation of solvents in EP-A-1 072 620.

Suitable fillers, in addition to the fiber fillers specified in EP-A-1 072 621, e.g., polyamide fibers, are customary particulate fillers.

In general, said particulate fillers comprise customary inorganic filling elements, such as kaolin or other aluminosilicates, or customary organic filling elements such as wood flour.

The incorporation of the activators, auxiliaries, additives, and fillers is not critical and may take place in accordance with customary methods.

The woodbase materials of the invention are used in particular in civil engineering, building construction, shipbuilding, automotive construction, and aircraft construction.

The following examples are intended to illustrate the invention in more detail.

### EXAMPLE 1

A stirred vessel was charged with 500 g of a 50/50 mixture of 2,4′- and 4,4′-diphenylmethane diisocyanate and this initial charge was heated with stirring to 80° C. 345 g of castor oil (with an OH number of 160 mg KOH/g) were slowly added.

After the end of the addition, stirring was continued for 60 minutes, after which the product was cooled to 25° C. and discharged.

The product had an NCO content of 14.3% by weight and a viscosity of 7200 mPas at 25° C.

### EXAMPLE 2 (COMPARATIVE)

The procedure described in Example 3 of EP-A-1 072 620 was repeated.

Testing:

99.2 parts of the adhesives from Examples 1 and 2 were mixed with 0.8 part of 2,2′-dimorpholinodiethyl ether and bonded in accordance with the instructions of DIN EN 302, part 1.

The tensile shear test gave the following results:

Tensile shear test to DIN EN 302, part 1

| | Minimum | | |
|---|---|---|---|
| | requirements in | | Example 2 |
| Treatment | DIN EN 302 | Example 1 | (comparative) |
| A1 | | | |
| 0.1 mm | 10 | 10.9 | 11.3 |
| 0.3 mm | 9* | | 9.2 |
| 0.5 mm | 9 | 10.6 | |
| 1.0 mm | 8 | 8.1 | |
| A4 | | | |
| 0.1 mm | 6 | 7.9 | 6.4 |
| 0.3 mm | 5* | | 5.3 |
| 0.5 mm | 5 | 7.1 | |
| 1.0 mm | 4 | 5.8 | |
| A5 | | | |
| 0.1 mm | 8 | 10.5 | 9.3 |
| 0.3 mm | 7.2* | | 7.2 |
| 0.5 mm | 7.2 | 10.6 | |
| 1.0 mm | 6.4 | 6.8 | |

*0.3 mm joint is not included in DIN EN 301, requirement corresponds to 0.5 mm joint.
Treatment A1: 7 days' storage under standard climatic conditions (20 ± 2° C.; 65 ± 5% relative humidity)
Treatment A4: 7 days' storage under standard climatic conditions (20 ± 2° C.; 65 ± 5% relative humidity), followed by 6 h submersed in boiling water, then 2 h submersed in water at 15 ± 5° C.; specimen tested in the wet state
Treatment A5: 7 days' storage under standard climatic conditions (20 ± 2° C.; 65 ± 5% relativ humidity), followed by 6 h submersed in boiling water, then 2 h submersed in water at 15 ± 5° C., then 7 days' drying under standard climatic conditions (20 ± 2° C.; 65 ± 5% relative humidity); specimen tested in the dry state

We claim:

1. A woodbase material comprising wood pieces glued using an adhesive composition comprising
an isocyanato-bearing prepolymer (prepolymer P) derived from
A) a component A comprising
A1) from 75 to 100% by weight of a triglyceride having two or more reactive groups which may react with isocyanate groups in an addition reaction (triglycerides A1), and
A2) from 0 to 25% by weight of another compound having one or more reactive groups which may react with isocyanate groups in an addition reaction (component A2), and
B) a component B comprising a polyisocyanate
if desired, customary auxiliaries and additives
if desired, an activator, and
if desired, a filler.

2. A woodbase material as claimed in claim 1, which is glued laminated board, continuous wooden board, plywood or coreboard.

3. A glued laminated board or continuous wooden board as claimed in claim 2, comprising wooden boards whose narrow edges are joined by glued finger joints.

4. A glued laminated board as claimed in claim 2 or 3, wherein the side faces of the boards have been glued using an adhesive composition as set forth in claim 1.

5. A glued laminated board as claimed in claim 3 or 4, wherein the adhesive composition is substantially free from filler.

6. A woodbase material as claimed in any of claims 1 to 5, wherein the reactive groups of the triglycerides A1 which may react with isocyanate groups in an addition reaction are selected from the group consisting of primary amino, secondary amino, alcoholic hydroxyl, and mercaptan groups.

7. A woodbase material as claimed in claim 6, wherein the triglycerides A1 are derived from hydroxycarboxylic acids.

8. A woodbase material as claimed in claim 7, wherein the triglycerides A1 comprise castor oil.

9. A woodbase material as claimed in any of claims 1 to 8, wherein component A2 primarily comprises polyols having a molecular weight of less than 400 g/mol.

10. An adhesive composition consisting essentially of
up to 99.99% by weight of an isocyanato-bearing prepolymer (prepolymer P) derived from
A) a component A comprising
A1) from 75 to 100% by weight of a triglyceride having two or more reactive groups which may react with isocyanate groups in an addition reaction (triglycerides A1), and
A2) from 0 to 25% by weight of another compound having one or more reactive groups which may react with isocyanate groups in an addition reaction (component A2), and
B) a component B comprising a polyisocyanate,
from 0 to 20% by weight of customary auxiliaries and additives,
from 0 to 10% by weight of an activator, and
from 0 to 20% by weight of a filler.

11. An adhesive composition consisting essentially of
up to 99.99% by weight of an isocyanato-bearing prepolymer (prepolymer P) derived from
A) a component A comprising
A1) from 75 to 100% by weight of a triglyceride having two or more reactive groups which may react with isocyanate groups in an addition reaction (triglycerides A1), and
A2) from 0 to 25% by weight of another compound having one or more reactive groups which may react with isocyanate groups in an addition reaction (component A2), and
B) a component B comprising a polyisocyanate,
from 0 to 20% by weight of customary auxiliaries and additives, and
from 0.001 to 10% by weight of an activator.
